(19) United States
(12) Patent Application Publication
(10) Pub. No.: US 2023/0289131 A1
(43) Pub. Date: Sep. 14, 2023

(54) METHOD AND SYSTEM FOR DYNAMICALLY GENERATING DIFFERENT USER ENVIRONMENTS WITH SECONDARY DEVICES WITH DISPLAYS OF VARIOUS FORM FACTORS

(71) Applicant: HANDHELD VENTURES LLC, Newark, DE (US)

(72) Inventor: Ely Tsern, Los Altos, CA (US)

(21) Appl. No.: 17/933,438

(22) Filed: Sep. 19, 2022

Related U.S. Application Data
(63) Continuation of application No. 17/222,759, filed on Apr. 5, 2021, now abandoned.
Application No. 17/222,759 is a continuation of application No. 16/518,822, filed on Jul. 22, 2019, now abandoned.
Application No. 16/518,822 is a continuation of application No. 14/752,535, filed on Jun. 26, 2015, now abandoned.
Application No. 14/752,535 is a continuation of application No. 12/554,427, filed on Sep. 4, 2009, now abandoned.
(60) Provisional application No. 61/096,172, filed on Sep. 11, 2008.

(51) Int. Cl. G06F 3/16; G06F 3/14; G06F 3/041; G06F 3/04842; G06F 3/04847

(52) U.S. Cl. CPC G06F 3/167; G06F 3/1415; G06F 3/1438; G06F 3/1454; G06F 3/0412; G06F 3/04842; G06F 3/04847; G09G 2360/02; G09G 2370/16; G09G 2354/00

(57) ABSTRACT

Exemplary embodiments of methods and systems that dynamically generate different user environments from a handheld device for secondary devices with displays of various form factors are described. In one embodiment, a method includes generating a user environment for the handheld device; auto-detecting a configuration of the secondary device over an interface; generating at least a part of a different second user environment based on the configuration of the secondary device; transmitting the second user environment over the interface; and displaying at least a part of the second user environment on the second display.

### CROSS-REFERENCE TO RELATED APPLICATIONS

This application claims the benefit of Provisional Application Ser. No. 61/096,172 filed Sep. 11, 2008, which is herein incorporated by reference. This application is also related to patent application Ser. No. ______, entitled “Expandable System Architecture Comprising a Handheld Computer Device That Dynamically Generates Different User environments With Secondary Devices With Displays of Various Form Factors;” and related to patent application Ser. No. ______, entitled “Display Device For Interfacing With a Handheld Computer Device That Dynamically Generates a Different User Environment For The Display Device”, both filed on the same date as the present application and assigned to the assignee of the present application.

### BACKGROUND OF THE INVENTION

Silicon, packaging, and software technology improvements are increasing levels of integration and functionality into a handheld computer device (“handheld device” or “handheld computer”). Examples of these handheld devices include mobile cellphones, “smart” phones, personal digital assistants (“PDAs”), handheld computing devices, and wearable computing devices, with display sizes typically 4″ diagonal or smaller. Improved processing power, storage, wireless connectivity, and software for handheld devices may provide enough functionality to perform the same functionality of many computing devices that are physically larger, such as notebook computers, desktop computers, automobile navigation display systems, televisions, and even set-top boxes and consoles that attach to or are incorporated into television displays.

However, many applications that typically run on larger computing devices lose functionality when they are run on the physically smaller displays and form factors of handheld devices. For instance, many interactive productivity applications, particularly for content generation such as spreadsheets, presentations, and media production and manipulation, are better suited for a larger display, such as a book-sized display or larger desktop display. Furthermore, other user input devices, such as keyboards, pointing devices (e.g., a mouse or trackball), or even touch-screen interfaces, are commonly used to optimize productivity and efficiency when working on computer applications with the larger display. As a result, today, people often use both handheld devices and larger computer devices to handle the wide array of communication, information, entertainment and computing needs. However, the redundant replication of hardware and software in multiple computing devices may result in greater overall cost, larger form factor, higher power consumption, inefficient synchronization, a more poorly unified user experience, and higher information technology (“IT”) maintenance efforts.

A conventional notebook-desktop dock architecture allows a notebook computer, together with a larger secondary display appliance (e.g. computer monitor), to function like a desktop computer. Conventional display interfaces for notebook computers allow video and audio to be sent to an auxiliary display, such as a large desktop display or projector for presentations. With these interfaces, the operating system of the portable personal computer either simply replicates or extends its graphical user interface (GUI) to the auxiliary display. In this case, the functionality and user environment of the portable personal computer is largely identical on the auxiliary display as it is on the native display of the portable personal computer.

Similarly, an existing cell phone companion display device called the Redfly device (made by Celio Corporation) simply extends or replicates the same GUI environment of the cell phone operating system (in this case, Windows Mobile OS) on the display of the larger Redfly appliance.

Because of the large disparity in their form factors, the user environments for a handheld device and a conventional notebook or desktop PC should naturally be significantly different to provide a more efficient and desirable user experience. For example, a handheld mobile device, such as the Apple iPhone, may deliver an optimized user environment for a handheld form factor, such as icon-driven, gesture-based touchscreen user interface, while a traditional personal computer (PC) delivers a very different desktop/windows-based environment for notebook and desktop form factors using a keyboard and mouse or trackpad. Therefore, to provide the best user experience, the handheld mobile device and larger computer devices, such as the traditional notebook or desktop personal computer, should be optimized for different user environments that includes user input mechanisms, GUIs, application types and interfaces, and OS functionality and environments. Because of these differences, the simple replication or extension of a handheld mobile device user environment on a larger secondary display appliance, as exemplified in the existing notebook-desktop dock architecture or Redfly device, may not be optimal and indeed may be inadequate when enabling a handheld computer to function effectively like a larger notebook or desktop computer or any significantly larger compute device or display appliance.

### BRIEF SUMMARY OF THE INVENTION

Exemplary embodiments provide methods and systems that dynamically generate different user environments from a handheld device for secondary devices with displays of various form factors are described. In one embodiment, the method includes generating a user environment for the handheld device; auto-detecting a configuration of the secondary device over an interface; generating at least a part of a different second user environment based on the configuration of the secondary device; transmitting the second user environment over the interface; and displaying at least a part of the second user environment on the second display. The embodiments include an operating system that enables a handheld computer device to transform larger secondary devices with displays into larger form-factor computers or computer appliances that have different user environments, optimized for each form-factor and may be personalized for the individual user.

In another embodiment, a method for dynamically generating different user environments from a computing device for use on a secondary device is disclosed. Aspects of the embodiment include generating a first user environment, which includes a graphical user interface displayed on a display of a computing device; communicating over an interface with the secondary device having a second display; generating a second user environment with a different second graphical user interface based on a configuration of the secondary device; and transmitting the second graphical user interface across the interface for display on the second display.

### BRIEF DESCRIPTION OF SEVERAL VIEWS OF THE DRAWINGS

FIG. 1 illustrates an exemplary embodiment of an expandable system architecture comprising a self-configuring handheld device that is usable with secondary devices having displays of various form factors.

FIG. 2 illustrates an exemplary embodiment of a process for using a self-configuring handheld device with secondary devices having displays of various form factors in an expandable system architecture.

FIG. 3 illustrates an exemplary embodiment of a display device compatible with a handheld device that is usable with secondary devices having displays of various form factors.

FIG. 4 illustrates an exemplary embodiment of an operating system for a handheld device that is usable with secondary devices having displays of various form factors.

FIG. 5 illustrates an exemplary embodiment of a process for using a self-configuring handheld device with secondary devices with varying form factors.

FIGS. 6A-6C illustrate exemplary embodiments of a handheld device generating different second user environments to various secondary devices with displays FIG. 7 illustrates an exemplary embodiment of a handheld device and its internal components.

FIG. 8 illustrates an exemplary embodiment of a user environment.

### DETAILED DESCRIPTION OF THE INVENTION

The exemplary embodiments relate to a method and system for dynamically generating different user environments for use with secondary devices having displays of various form factors. The following description is presented to enable one of ordinary skill in the art to make and use the invention and is provided in the context of a patent application and its requirements. Various modifications to the embodiments and the generic principles and features described herein can be made. Thus, the present invention is not intended to be limited to the embodiments shown, but is to be accorded the widest scope consistent with the principles and features described herein.

This exemplary embodiments provide methods that enable a handheld computer device to transform larger secondary devices with displays into larger form-factor computers or computer appliances that have different user environments, optimized for each form-factor and may be personalized for the individual user. Exemplary embodiments provide a self-configuring handheld device having an operating system that enables dynamic generation of different user environments for secondary devices with displays of various form factors. The handheld device has its own display and computer resources, such as processor, memory and storage, along with its own user environment for that display and form factor. Once communication is established between the handheld device and a secondary device via an interface, the handheld device determines characteristics, features and/or configuration settings of the secondary device and the handheld device initiates a different second user environment that matches the usage context of the form factor of the secondary display device. The handheld device then transmits the reconfigured environment to the secondary device via the interface. All the computation required to generate and operate the second user environment may be performed on the handheld device. In one embodiment, the reconfigured UI environment may include remote or extended control of the user input devices of the secondary device such that a user may access and interact with the handheld device through the input devices of secondary device, which may have peripherals that are optimized for a larger device form factor, such as a larger screen, full-sized keyboard, pointing device, and web-cam, for example.

The expandable architecture described herein can allow a handheld computing device, when used with a larger display device, to function like a larger personal computer, such as a notebook, netbook or desktop personal computer (“PC”). To support this, the handheld device may generate different user environments for native handheld and extended PC modes, because of 1) a substantial difference in form factors, and 2) the desire to maintain both an optimized handheld user experience and the legacy, familiarity, and compatibility of a PC environment when used in a secondary PC form factor. Compared to the existing handheld computer and notebook PC combination, this expandable architecture can therefore enable replacing the more expensive, larger notebook PC with a lower cost, smaller form factor notebook display appliance.

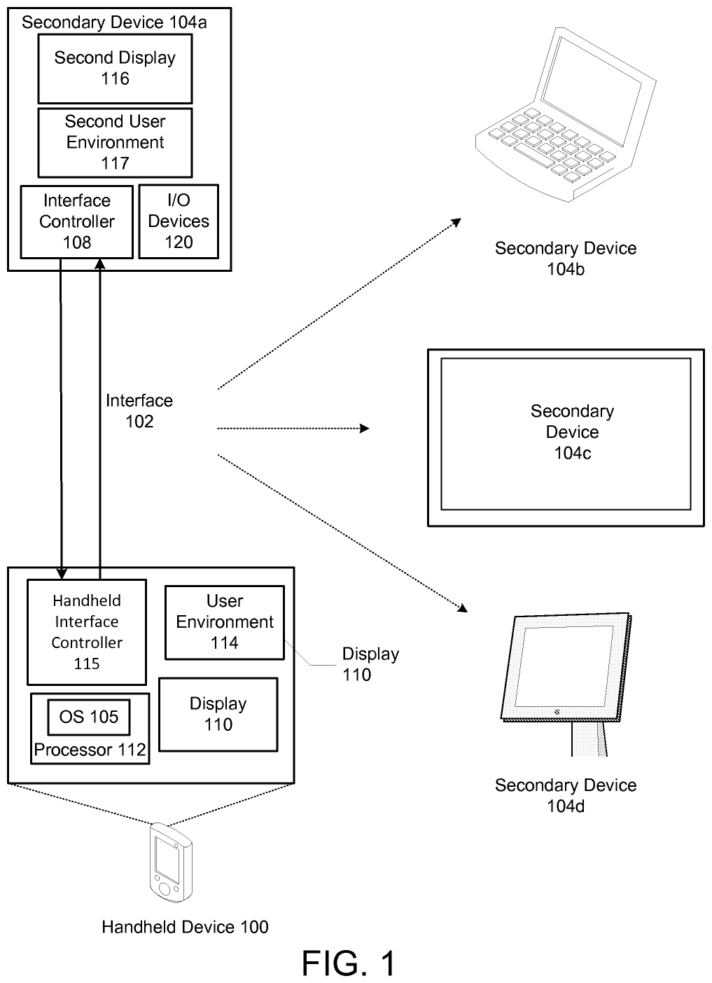

FIG. 1 illustrates an exemplary embodiment of an expandable system architecture comprising a self-configuring handheld device that is usable with secondary devices having displays of various form factors. The system may include handheld device 100, an interface 102, and one or more secondary devices 104a, 104b, and 104c. Although only shown for secondary device 104a, each of the secondary devices 104a, 104b, 104c, and 104d includes a second display 116, and may include at least one set of input/output devices (“I/O” devices 120), which together with the second display 116, form a portion of the second user environment 117.

The handheld device 100 may be any electronic device operative to provide computer functionality. Examples of handheld devices may include any small device that fits in a hand or smaller, including cell phones, “smart” phones, personal digital assistants (PDAs), and wearable computing devices.

FIG. 7 illustrates a detailed block diagram of an exemplary handheld device 700. The handheld device 700 may include a display 701, a system-on-chip (SOC) 702 incorporating at least one processor 703, main memory 704, mass storage 705 (such as flash non-volatile storage devices), and cellular wireless subsystem 706 including a baseband processor 707, RF devices 708, and antenna 709. The system-on-chip 702 may include both a central processing unit and a graphics processor. The graphics processor may be capable of generating the content for the display of the handheld device and the secondary device display 116. The handheld device 700 may also include a local communications link 712, which may include a local wireless interfaces 710 (such as WiFi or Bluetooth) or wired I/O interfaces 711 (such as USB or Firewire) connects to the interface 102. The interface controller 713 manages the communication, protocol and/or information over the interface to a secondary device. The handheld device 700 may also include a user input and output devices (such as audio out, microphone, vibration motor, and speaker) and sensors (such as an accelerometer or proximity detector) 714.

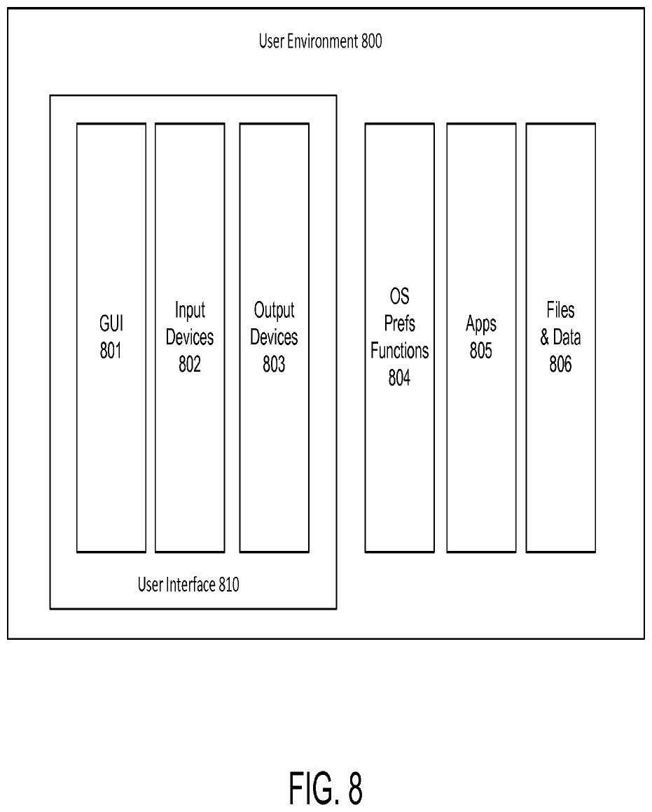

In FIG. 1, a simplified diagram of a handheld device 100 includes a display 110, at least one processor 112 executing operating system (OS) 105, an interface controller 115 connected to an interface 102, and a user environment 114. The display 110 displays a portion of the user environment 114, which may include a GUI and be optimized for a handheld form factor. A secondary device 104a includes a second display 116, an interface controller 108 and I/O devices 120. The second display 116 displays a portion of a second user environment 117, which may include a second GUI and be optimized for the form factor of the secondary device 104a. The user environment 114 and/or second user environment 117 may include multiple components, as shown in FIG. 8.

FIG. 8 is a diagram illustrating an embodiment of a user environment corresponding to user environment 114 and/or second user environment 117. The user environment 801 may include a user interface 810, which may comprise a graphical user interface (“GUI”) 801 shown on a display, one or more user input devices 802, such as a keyboard, buttons, accelerometers, sensors, touch screens, pointing devices, a camera, a microphone, or remote controls, and one or more output devices 803, such as speakers, audio output jacks, and mechanical feedback devices, such as a vibration motor or actuator. The user environment 800 may further include selected access to various applications (“apps”) 805 and/or digital content including files and data 806. Digital content may be stored data that is accessible, such as video files, audio files, and/or files generated by productivity software, for example. The user environment 800 may further include certain operating system functionality or preferences 804 accessible by a user.

Referring again to FIG. 1, the secondary devices 104a, 104b, 104c, and 104d include second displays 116 that may take a variety of form factors. Examples of the secondary device may include a variety of display appliances, such as portable notebook-sized display appliances, televisions, computer monitors, and car navigation systems. While the second display 116 may be substantially the same as display 110 (e.g., if the secondary device 104a is another handheld device), the second display 116 may differ from the display 110 (e.g., be a different size or have a different resolution) as part of a secondary device with a significantly different form factor, which may make the second display suitable for different functionality, user interface, and user environment 117. For example, the secondary device 104a may take the form of a desktop computer device with a display. Secondary device 104b, by contrast, may take the form of a simplified notebook display appliance. The simplified notebook display appliance may include a display, keyboard, battery, pointing device, and compatible interface 102 to handheld device 100, but is not required to have a dedicated CPU, graphics processor, or memory typically included with a full notebook computer, although the exemplary embodiment can be used with a full notebook computer with a compatible interface 102. Secondary device 104c in another embodiment may take the form of a larger television display. And another exemplary secondary device may take the form of an automobile display (not shown). The handheld device 100, as described below, may provide different functionality for each secondary device 104a, 104b, 104c, and 104d by generating a different user environment for each of the secondary devices 104a, 104b, 104c, and 104d.

While not shown in the handheld device 100, other components may be included in the handheld device 100 in accordance with exemplary embodiments of the present invention. These elements may include a graphics controller and frame buffer to support at least two displays of various sizes (optionally simultaneously), various input mechanisms, such as a touch screen, keyboard, accelerometer, and/or image sensor, a local wireless and/or wired link, scratch memory for processing and mass storage memory, such as a non-volatile flash drive or a rotational hard drive. Furthermore, the handheld device 100 could include one or more processing cores with general, specialized, or fixed functions, such as general purpose CPU, floating point processor, graphics processing unit (GPU), video processing (e.g., H.264), audio processing, cellular baseband, and/or power management controller. The handheld device 100 could also provide cellular telephone functionality, and could include a cellular data link and/or cellular voice capability. The handheld device 100 could also include a local area network wireless link, such as a WiFi link, or personal area network wireless link, such as Bluetooth.

According to the exemplary embodiment, once the handheld device 100 is in communication with one of the secondary devices 104a via interface 102, the handheld device 100 enables a different second user environment 117 to be provided across the interface 102 that is displayed and accessible on the second display 116. The different second user environment 117 is different from user environment 114 displayed on the handheld device 100, and may be configured by the handheld device 100 to be adapted for the form and functionality of the secondary device 104a, as described below. Enabling the second user environment 117 may include both generating at least a part of the second user environment 117 (e.g., a second GUI) and transmitting the second user environment 117 to the secondary device 104a via the interface 102. In addition to a second GUI, the second user environment 117 may also include remote control of the I/O devices 120 in communication with the secondary device 104a by the handheld device. Such control may enable a user to seamlessly access and interact with the handheld device 100 using the I/O devices 120, which may have a larger display and substantially different I/O devices, such as a full-sized keyboard and mouse or trackpad, for example. The second user environment 117 may further include access to a plurality of applications, which may be the same or different from the applications accessible on the first user environment 114, and/or at least one of data content and digital content, which may be shared or different the content available on the first user environment 114. An application may also be designed to run in multiple user environments, delivering the same functionality for each user environment but providing different GUI's for each.

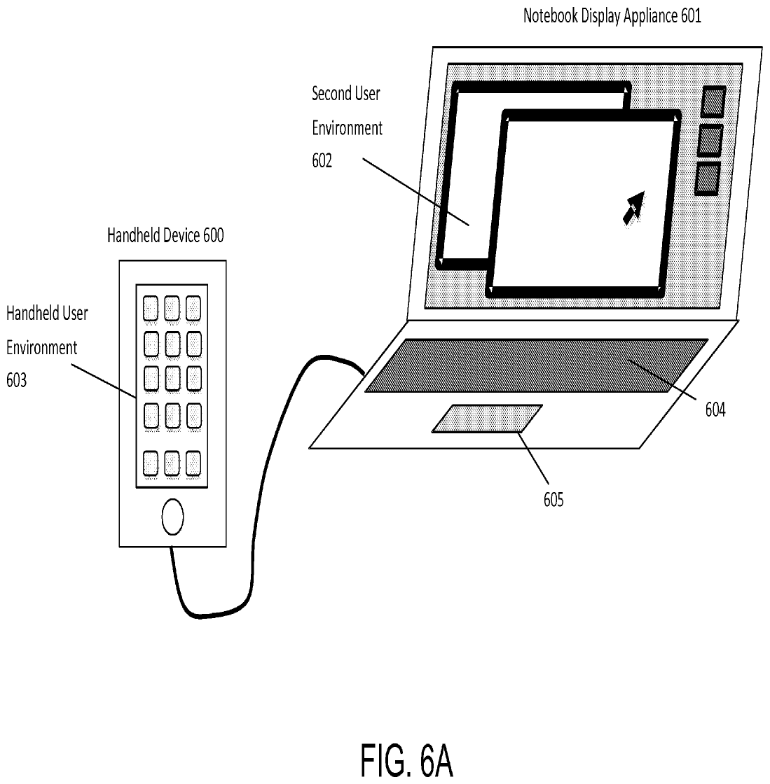

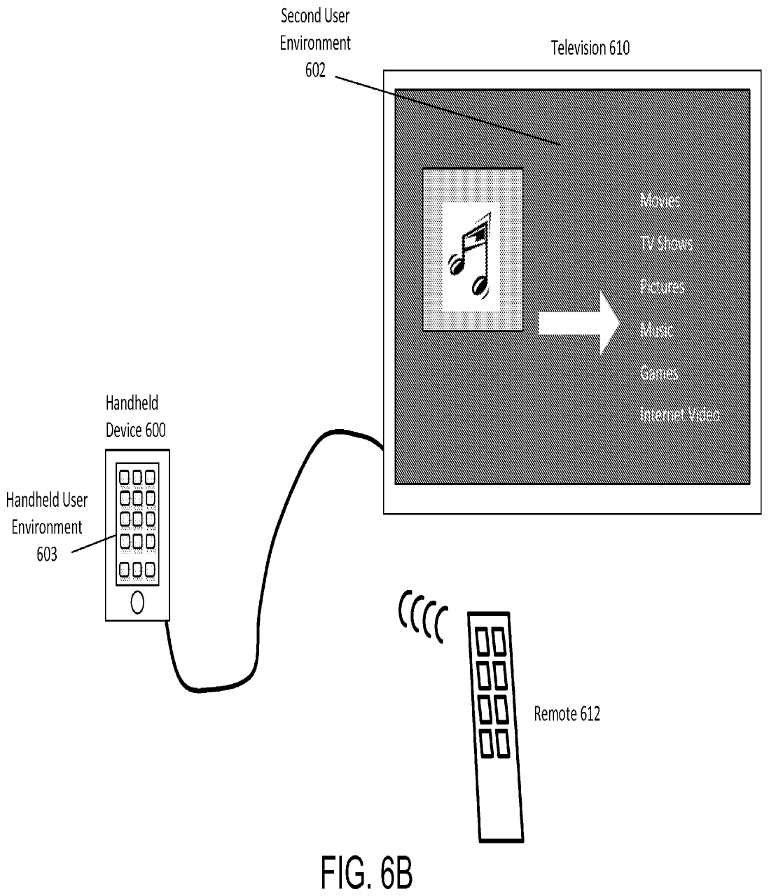

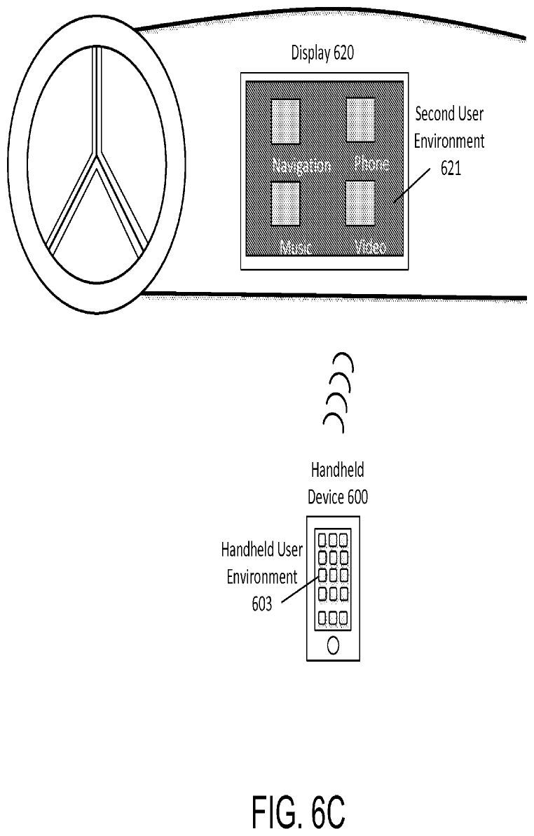

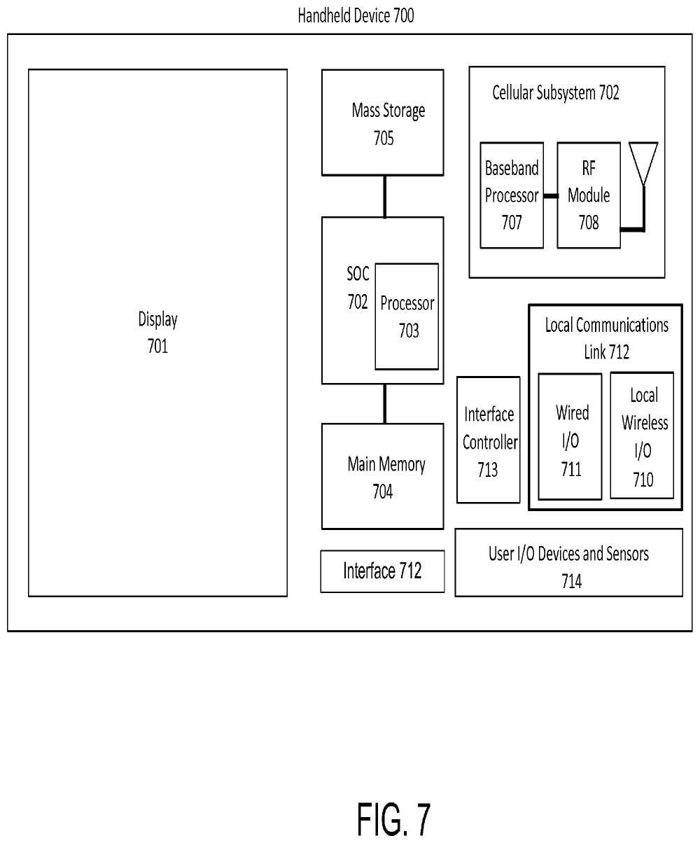

FIGS. 6A-6C illustrate a single handheld device 600 that generates multiple user environments on various secondary devices with displays. In the first example shown in FIG. 6A, a portable notebook-sized display appliance 601 including display 602, keyboard 604, trackpad 605, and battery (not shown) connects with a handheld device 600 over an interface 102. The user environment of the handheld device 603 includes an icon-based touchscreen GUI with finger gesture user control. The handheld device 603 also simultaneously generates a second user environment 602 that is optimized for the display appliance 601 and is very different from the handheld user environment 603. The GUI in 602 is a windows-based interface, like that of Microsoft Windows or Mac OSX, and is controlled by a keyboard and pointing device, such as a trackpad or mouse. The applications that run in the second user environment are typically of those used in a PC computer, may or may not be available in the first handheld user environment, and are optimized for the windows-based GUI. In this embodiment, the secondary display appliance 601 does not have its own compute resources, such as a processor and memory. The entire secondary user environment is generated and controlled by the resources of the handheld device 600 and as a result, the notebook display appliance 601 appears to the user to operate just like a fully functional notebook personal computer. The handheld user environment 603 may be accessible on the handheld device 600 while being connected to the notebook display appliance 601, or the handheld user environment 603 might transform or reconfigure into a different GUI or application set when connected to the notebook display appliance 601.

In the second example shown in FIG. 6B, the handheld device 600 is connected to a television device 610 over an interface 102 and is generating a second user environment 611 that is optimized for a television form factor. The GUI in 611 is very different from the GUI in 601 or 603 and is optimized to be controlled with a remote control 612, showing just a few selections in a list of various digital content categories that a user might desire to watch on the television, such as movies, TV shows, pictures, music, and games. The applications that are available from the second user environment 611 may be different or a subset of the applications available in the handheld user environment 603. Also the personal media content that is available and authorized on the handheld device 600, whether stored on the handheld device 600 or stored on a remote server on the internet but authorized by the device 600, is accessible by the user over the second user environment 611. The entire secondary user environment is generated and controlled by the resources of the handheld device 600 and as a result, any given television 610 can appear like the user's personal television setup at home. In this embodiment, the remote control 612 communicates wirelessly with either the television 610 or the handheld device 600. In other embodiments, the handheld device 600 might also serve as the remote control itself. The handheld user environment 603 may be accessible on the handheld device 600 while being connected to the television 610, or the handheld user environment 603 might transform or reconfigure into a different GUI or application set when connected to the television 610.

In the third example shown in FIG. 6C, the handheld device 600 is connected to a automobile display device 620 over an interface 102 and is generating a second user environment 621 that is optimized for an automobile display form factor. The GUI in 621 is very different from the GUI in 601, 603, or 611 and is optimized to be controlled with a touchscreen display, auxiliary buttons, and voice recognition control connected the automobile display device 620. The applications that are available in the second user environment 621 may be different or a subset of the applications available in the handheld user environment 603 and might include those typically useful in the car, such as GPS navigation, phone, information access, and media playback, such as music and video. The connection between the handheld device 600 and the automobile display device 620 may be a wired dock or a wireless link, with seamless operation between the two connection modes. The handheld user environment 603 may be accessible on the handheld device 600 while being connected to the automobile device 620, or the handheld user environment 603 might transform or reconfigure into a different GUI or application set when connected to the automobile device 620.

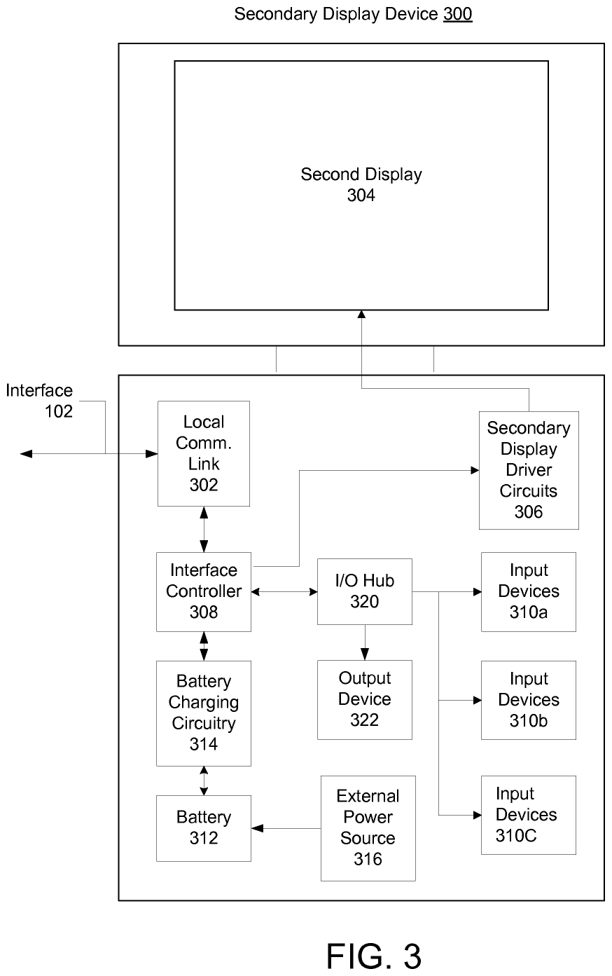

In operation, the handheld device 100 may auto-detect configuration information about the secondary device 104a by receiving the configuration information about the secondary device 104a over the interface 102 via interface controllers 108 and 111. The configuration of the secondary device may include the type, form factor, and properties of the secondary device 104a, the type of input/output devices accessible through the second display device 104a (if any), the compute capabilities of the secondary device (if any), the storage of the secondary device (if any), the nature of the power supply of the secondary device 104a, the type of network data link accessible through the secondary display device 104a (if any), the existence of an extended radio or cellular antenna, and/or the type of extended I/O ports (e.g., USB and/or FireWire ports) accessible through the secondary device 104a (if any). The configuration information may also include encrypted personal identification information, which would prevent unauthorized device pairing. Security configuration software on the handheld device 100 would allow the user to control exactly which secondary devices are allowed to connect and operate with the handheld device 100 over the interface 102. Configuration information may be encoded, encrypted and/or compressed into a simplified code assignment, which may represent a specific secondary device configuration. The secondary device may also have a unique ID code which can be used by the handheld device 100 to identify the specific configuration of the secondary device. The interface controller 108 providing the configuration information of the secondary device 104a to the handheld device 100 is described in further detail in FIG. 3. The interface controller 111 on the handheld device 100 controls the interface 102 and may be a separate chip or a integrated on to a portion of a larger chip, such as a system-on-a-chip (SOC) or processor, for example.

In one embodiment, the handheld device 100 detects a secondary device 104a over the interface 102 and automatically enables a secondary user environment 117. In another embodiment, the handheld device 100 detects a secondary device 104a over the interface 102 and requires the user approval before enabling a secondary user environment 117. This user approval can be a one-time event or required every time the secondary device is detected. In another embodiment, the handheld device 100 enables the user to configure whether and when user approval is required for any specific secondary device 102a.

In response to receiving the configuration information of the secondary device 104a, the handheld device 100 may transmit video and audio via the interface 102 to the secondary device 104a. In another embodiment, the handheld device 100 may also transmit control over I/O devices 120 and control over display settings to the secondary device 104a. In another embodiment, the handheld device 100 may also perform power management control of the secondary device 104a and any of its components via the interface 102.

In a further aspect of the exemplary embodiment, the handheld device 100 may store a configuration of the secondary device 104a to which an interface has been made. The stored configuration can be identified along with a unique ID of the secondary device to allow the handheld device 100 to provide the second user environment 117 automatically at a later time, without being required to auto-detect the configuration of the secondary device 104a.

In addition to the aforementioned advantages, the system shown in FIG. 1 may provide a secure environment in an exemplary embodiment configured such that only video, audio, and control signals are shared between the handheld device 100 and the secondary devices 104a, 104b, 104c, and 104d. By not exporting other digital data or content, from the handheld device 100 to the secondary devices 104a, 104b, 104c, and 104d, the data content, which may contain private or sensitive material, may be retained and accessed only by the computing resources of the handheld device 100, thereby preventing sharing of the data content via the secondary device, and thus improving security.

In another embodiment, video may also be encrypted at the handheld device 100 and transferred to the secondary device 104a over the interface 102, where it may be decrypted on the secondary device by, for example, the interface controller 108.

The interface 102 may be implemented as a wired or wireless connection between the handheld device 100 and the secondary device 104a over which data may be transmitted between the handheld device 100 and the secondary device. Furthermore, the interface 102 may be implemented as a combination of wired and wireless connection between the handheld device 100 and the secondary device 104a, where there is seamless operation when switching between the wireless and wired modes. The data transmitted over the interface 102 may include data related to the operation of both the handheld device 100 and the secondary device 104a, and may specifically include data relating to the second user environment.

While the term “wired” may be applied to the interface between the handheld device 100 and the secondary devices 104a, 104b, 104c, and 104d, the term does not require that a wire physically connect the handheld device 100 and the secondary devices 104a, 104b, 104c, and 104d. In this context, a “wired” interface refers to a physical connection between the handheld device 100 and a secondary device, which may also be achieved using a dock, for example. An exemplary wired interface may include data streams or signals for display video, audio in, audio out, USB In (e.g., to the handheld device 100), one or more input devices (e.g., I/O devices 120 included in the secondary device 104, such as a keyboard, a camera, a mouse, game controllers, and/or ports), data link in (e.g., from a data link incorporated on the secondary device to be shared with the handheld device), and an external antenna (e.g., that is included in the secondary device 104). An exemplary wired interface may also include data streams for a secondary device control data link, which may control settings for the secondary device 104. For example, the secondary device control data link may include data pertaining to display brightness control (e.g., for second display 116), secondary device battery status and charging control, secondary device type, secondary device display features (size, resolution, type), a unique secondary device ID code, and/or control over any other hardware in accessories included in the secondary device. Also, an exemplary wired interface may include lines corresponding to power and ground, which may be used to supply power to the handheld device 100. Utilizing remote power access over a wired interface may be advantageous because it may be used to charge the battery of the handheld device 100. Remote power access may also be used to enable higher-performance modes of the processors and memory on the handheld device 100, or higher power modes of the wireless links for improved reception, or higher brightness of the handheld device display.

As stated above, the interface 102 may be wireless, which may, in an exemplary embodiment, include a merged data stream in each direction. The protocol for the merged data stream may include video data (which may be compressed or uncompressed), audio in/out data, USB accessories in (e.g., to the master, for multiple accessories as described above), and configuration data link data (e.g., to the master, as described above). In an exemplary embodiment, the interface 102 may be configured to seamlessly transition between wireless and wired operation. That is, the transition may be made without user intervention beyond making or removing a physical connection to the secondary device. Alternatively, the transition may be allowed upon user approval.

In an exemplary embodiment, multiple handheld devices may be used with a single secondary device using wireless or a multiplexed wireless interface. In such embodiments, the interface controller 108 may support multiple interfaces with different handheld devices simultaneously, and data sharing may be implemented in the form of a local network that may be used for file sharing, game playing, interaction, and the like.

Another exemplary embodiment of the handheld device 100 (in a cell phone form factor, for example) could have an interface with a thin notebook-sized display appliance 104b comprising the interface controller 108, a display, a battery, a keyboard, and a pointing device. Together the combined system of the handheld device 100 and the thin notebook display appliance could act as a full notebook PC at a lower cost point and in a more attractive form factor. Each device may operate with its own user environment optimized for each form factor. While connected, both the secondary device, in this example, a thin notebook-sized display appliance, and the handheld device are simultaneously functional and the user can use both at the same time. In an alternative embodiment, the display appliance 104b may have additional mass storage, such as a non-volatile flash storage array or a mechanical hard disk, which can be accessed and used by either the second user environment 117 or native user environment 117 when the secondary device 104a is connected to the handheld device 100.

In another embodiment, the handheld device 100 could have an interface with a media player, such as a home audio system or video player having its own display, wherein a user's preferred settings could be transmitted over the interface 102.

In another embodiment, the handheld device 100 could interface with a desktop display appliance, such as a computer monitor, that has a compatible interface (wireless and/or wired dock). A user could use a wireless interface to the desktop display appliance to immediately start working, or could dock the handheld device to provide power for the handheld device 100 and possibly work at a higher video resolution and/or performance.

In another embodiment, the handheld device 100 could interface with a personal computer over a universal compatible interface (wireless and/or wired dock). When a connection is established over the interface, the video input of the display of the personal computer may switch to be controlled by the handheld device. This may provide a secure way to use handheld device 100 on a personal computer, though if desired, data sharing may be allowed through configuration between the handheld device 100 and the personal computer.

In another embodiment, the handheld device 100 could interface with an automotive display (e.g., a GPS navigation screen or onboard display) over a universal compatible interface (wireless and/or wired dock). Like the aforementioned desktop display device, a user could use a wireless interface to the automobile display appliance to immediately start working, or could dock the handheld device 100 to provide power for the handheld device 100 and possibly work at a higher video resolution and/or performance. The handheld device 100 may then provide a secondary user environment that enables applications and information specific to the automobile form factor, such as at least one of location-based navigation, media playback, internet-accessed information, communication, car monitoring and/or maintenance, and/or personal car configuration preferences services.

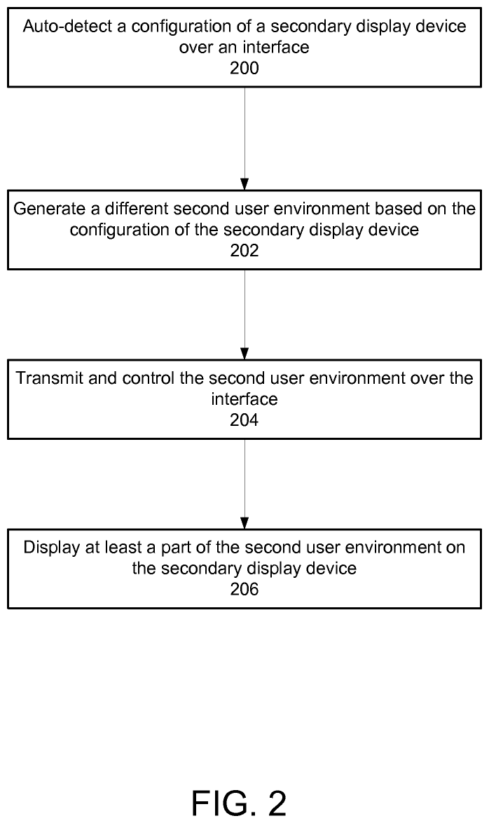

The handheld device 100, in an exemplary embodiment, could interface with a television monitor, such as a home television set, over a universal compatible interface (wireless and/or wired dock). As in other devices, a user could use a wireless interface to the television monitor to immediately start providing a second user environment optimized for a television monitor usage profile, or could dock the handheld device 100 to provide power for the handheld device 100 and work at a higher video resolution and/or performance. The handheld device 100 may generate the on-screen menu and icon selection in which users access media content. In this way, the handheld device 100 is used as a gateway for streaming media and/or to authorize content streaming directly to connected living room TV. The handheld device 100 may in some embodiments be used as a remote control or motion controller/pointer for selecting and watching media on the television monitor. Alternatively, the handheld device 100, in an exemplary embodiment, could interface with television set-top appliance, such as a DVR, tuner, or game console, In this mode, the handheld device may provide just data and content which can be used by or shared with the set-top appliance. For example, the handheld device 100 may be used to store a gaming identity or to save content for a game to be played on a local game console, which gets game content over the internet or from a local game console's local hard or disc drive. Alternatively, the handheld device might share authorization to personal media content, which is stored either on the handheld device, other devices on the local area network, or on a remote server on the internet. The set-top appliance may then use this authorization to access the media content and deliver it to the television monitor. FIG. 2 illustrates an exemplary embodiment of a process for using a self-configuring handheld device with secondary devices having displays of various form factors in an expandable system architecture. A configuration of the secondary device 104 is auto-detected over the interface 102 (block 200). In an exemplary embodiment, the auto-detection may occur after communication is established over the interface 102 and may be performed by a combination of the OS 105 of the handheld device 100 and the interface controller 108 of the second display device 104a. The configuration may include information regarding the hardware and functionality included within the secondary device 104, and may include information (e.g., properties) regarding the type of display device connected to the handheld device 100, any input devices available on the secondary device 104, the type and properties of secondary device, and the presence of any additional elements, such as an additional network data link or additional storage.

The configuration of the secondary device is auto-detected, meaning that the handheld device 100 detects the configuration without requiring user intervention. The auto-detection may be caused by the handheld device receiving information regarding the secondary device configuration over the interface, and may take place when communication is established between the handheld device 100 and the secondary device 104a via the interface 102. The information regarding the secondary device configuration may take the form of a code in an exemplary embodiment, which may be used in conjunction with a database on the handheld device to allow the auto-detection to take place. The database may also be updated as the configuration of the secondary device changes depending on user configuration.

In an alternative embodiment, the handheld device 100, upon detecting a connection with a secondary device 104a over the interface 102, automatically provides a default second user environment to the secondary device 104a without receiving any configuration or type data from the secondary device 104a. This embodiment may be useful when a handheld device is designed to work only with secondary devices that have a specific pre-defined configuration.

In an exemplary embodiment, a user input may be received to initiate the auto-detection process on either the handheld device 100 or the secondary device 104a. Such an embodiment may be advantageous because the user may not desire the handheld device to interact with secondary devices within wireless range. In another embodiment, however, the handheld device may initiate auto-detection without requiring user intervention, for instance, with some preconfigured paired secondary devices. Such an embodiment may be advantageous because seamless transitions to the use of certain secondary devices may improve efficiency. Alternatively, in a simplified embodiment, the handheld device 100 may be configured to always generate the same secondary user environment whenever a secondary device is connected over the interface 102. In such an embodiment, the set of secondary devices that will work with the handheld device may be limited, but this may be acceptable for certain users.

The operating system 105 of the handheld device 100 can be configured to generate a different second user environment 117 based on the configuration of the secondary device 104a (block 202), and the handheld device transmits and controls the second user environment 117 over the interface 102 (block 204). In an exemplary embodiment, the second user environment 117 is enabled by the OS 105 of the handheld device 100, and transmitted by the handheld device 100 over the interface 102 to the interface controller 108 of the secondary device 104a. In one embodiment, the second user environment 117 may be generated by the OS 105, such as when displaying an OS desktop for example. In another embodiment, the second user environment 117 may be generated by a combination of the OS 105 and an application program. In this embodiment, the OS 105 may provide libraries and/or an application program interface that the application uses to generate the second user environment 117.

The second user environment 117 can be controlled by the OS 105, or, in an exemplary embodiment, by a virtualized OS that is different from the OS 105 and runs on the handheld device 100. In an exemplary embodiment, at least a part of the second user environment 117, such as the GUI, is generated and displayed on the display of the secondary device, for example. The second user environment 117, when transmitted over the interface 102, may then include any or all components of the second user environment, as defined above.

The second user environment 117 has at least one difference from the first user environment 114 on the handheld device. This difference may be present in any element of the second user environment 117, which, as described above, may include the graphical user interface that presents video and/or audio content provided by the OS, I/O devices, or an application, and/or digital content executed by or originated from the handheld device 100. In an exemplary embodiment, the second user environment 117 may have a different resolution than the user environment 114. Furthermore, in an exemplary embodiment, the second user environment 117 may provide control over different I/O devices from the user environment 114, although in some embodiments, the second user environment 117 may provide control over I/O devices on the handheld device 100 in addition to I/O devices in communication with the secondary device 104a (e.g., buttons on the handheld device, or I/O ports). In a further embodiment, the second user environment 117 may be user-customized to differ from a default second user environment provided by the OS 105 (e.g., provide different data access, and/or provide different applications).

In an exemplary embodiment, the handheld device 100 may enable a second user environment 117 that takes into account the configuration of the secondary device 104a that is auto-detected and automatically selects the best features between the first and second devices to use. For instance, if the secondary device has an improved network data access link (i.e., with higher bandwidth and availability), the handheld device 100 may automatically switch over to use the network data link of the secondary device 104a instead of the network data link of the handheld device 100. Other secondary device 104a features that may be utilized in a similar manner may include a better power source (e.g., a connection to a wall outlet instead of battery power, or a more powerful battery), an improved radio antenna, increased storage space, and the existence of additional I/O peripherals. By taking advantage of the features included in the configuration of the secondary device, improved functionality may be provided to a user.

In embodiments where the handheld device 100 has a wireless data connection to the internet, for example, the handheld device 100 can share the wireless data connection between the user environment 114 of the handheld device 100 and the second user environment 117. Similarly, wherein the secondary device 104a has its own network data connection which is accessible over the interface 102, the secondary device 104a may transmit information characterizing its data connection to the handheld device 100 over the interface 102. If both the handheld device 100 and the secondary device 104a have network data connections, the handheld device 100 can select the network data connection based upon a data connection factor. The data connection factor can include at least one of data bandwidth, availability, service cost and power consumption, for example. Alternatively, the handheld device can allocate the data connection from the secondary device 104a to the second user environment 117 and the data connection from the handheld device 100 to the user environment 114 of the handheld device 100.

In embodiments where the handheld device 100 has a location-sensing capability, such as GPS, the handheld device 100 can share the location information with both the user environment 114 of the handheld device 100 and the second user environment 117. Applications written for any second user environment 117 can utilize the location-aware information available with the handheld device 100. Similarly, any other sensors or information that is available on the handheld device 100, such as bio-sensors, motion sensors, directional sensors, image sensors, audio sensors, may be available to both the native handheld user environment 114 and any second user environment 117.

At least a part of the second user environment 117 is displayed on the second display 116 (block 206). By enabling the second user environment 117, the handheld device 100 can allow the user to interact with the second user environment 117, and utilize the functionality of the secondary device 104a. For example, visual aspects of the second user environment 117 (e.g., the GUI, and/or the output of an application) may be displayed on the second display 116, and control of the I/O device 120 can be activated, allowing the user to interact with content displayed on the second display 116. The second user environment 117 may also tailor the applications available to the user based on the configuration of the secondary device 104a in an exemplary embodiment. For instance, a notebook-sized or desktop display device might always present a personal computer-like user environment, using a window-based graphical user interface (e.g. Windows or OSX) and providing the user with applications typically used on a personal computer, such as productivity or content generation applications that are more effectively used with a larger display size, keyboard and mouse. Alternatively, a large-screen television secondary device 114a may provide the user an entertainment-specific menu or icon-driven interface that may provide convenient access to media content using a remote control device. A handheld device 100 can also enable multiple user environments and can work with more than one additional type of secondary devices.

The handheld device 100 may be configured to operate in one of a plurality of modes when the second user environment 117 is being displayed. For example, the handheld device 100 can be used in a remote control mode, including at least one of a remote control or a pointing device used to control and select operations displayed on the second display device 104a. The display 110 can be turned OFF in another mode. In another mode, the handheld device 100 may have full functionality of its native user environment 114 while the second user environment 117 is being displayed on a second display device 104a. In an exemplary embodiment, the user environment 114 may be replicated, accessible, and controlled in a window within the second user environment 117 shown on the second device display 104a. Alternatively, the second user environment 117 can be accessed, replicated or controlled within the native user environment 114. In another embodiment, the handheld device 100 may display an entirely different user environment on its own display 110 when connected to a secondary device 104a.

In one embodiment, the second user environment 117 transmitted to the secondary device 104a may also include control of the input devices 310 of the secondary device 104a. The input devices 310 can then allow a user to seamlessly access and interact with the handheld device 100 using the input devices of the secondary device 104a, which may have a larger display and better I/O devices, such as a full-sized keyboard and camera, for example.

FIG. 3 illustrates an exemplary embodiment of a secondary device 104a that is compatible with the self-configurable handheld device 100. The secondary device 300 may include a local communications link 302, a second display 304, secondary display driver circuits 306 that control the second display 304, and an interface controller 308. The local communications link 302 may be used to communicate with the handheld device 100 through interface 102, and may be a local wireless link and/or a wired link. The interface controller 308 may use the local communications link 302 to manage the communication, protocol and/or information over the interface 102.

The interface controller 308 may be configured to provide the configuration of the secondary device 300 and serve as a gateway to enable the second user environment 117 which is generated and controlled by the handheld device 100. For example, the interface controller 308 could provide information that enables control of any I/O devices 310 included with the secondary device 300, to the handheld device 100 using the interface 102. The interface controller 308 may also receive, video data of the second user environment 117 for display on the display 304 (e.g., a GUI, or the output of an application), for example. The interface controller 308 may be a separate chip or a integrated on to a portion of a larger chip, such as a system-on-a-chip (SOC) or processor, for example. In an exemplary embodiment, the secondary device 300 may be under the control of the handheld device 100 (e.g., based upon the master-slave model).

As stated above, the interface controller 308 may provide information regarding the configuration of the secondary device 300 to the handheld device 100. This information may be stored in non-volatile memory (not shown in figure) located on the secondary display device 300. This non-volatile memory may be located on a separate chip or component (such as mechanical disk or flash memory device) or integrated into another chip. The information may be sent using a secondary device code in an exemplary embodiment, which may be used in conjunction with a database on the handheld device 100 to allow the auto-detection to take place. In an exemplary embodiment, the handheld device 100 may connect only with secondary devices having a secondary device code previously stored upon the handheld device 100.

The interface controller 308 may, in an exemplary embodiment, manage wireless data compression and decompression, which may allow for reduced wireless bandwidth usage in secondary devices that utilize a wireless link. Furthermore, the interface controller 308 may manage seamless transition between wired and wireless connections in embodiments that support such functionality. The interface controller 308 may also manage security and encryption functionality, basic accessory power modes (i.e., vary between different power consumption states, such as off, sleep, etc.), and may be implemented in hardware (e.g., as a standalone chip, or in combination with other chip functionality, such as a system-on-a-chip, or a microcontroller) or in software. Each of these functions described can be integrated into the interface controller 308 or be located elsewhere in the system 300 to provide equivalent functionality.

The secondary device 300 may include other elements. For example, input devices such as any one or more of a keyboard 310a, a pointing device 310b (e.g., a mouse, or a trackball), a microphone, a touchscreen, a remote control paired with the secondary device 300, buttons, a printer, and/or a video camera 310c, for example, may be included. These input devices 310 may be integrated with the secondary device 300 into one unit (as shown), or separately connected to the secondary device 300. The input devices, along with at least one output device 322 (e.g., speakers for audio and/or a mechanical feedback device), may be controlled by an I/O hub 320.

The secondary device 300 may also include a battery 312 and battery charging circuitry 314 (e.g., for the handheld device 100 coupled to the secondary device 300), an external power source 316, an extended antenna (not shown in FIG. 3), a broadband data link (either wired or wireless, also not shown in FIG. 3), or additional input/output ports 318. The additional input/output ports 318 may include ports for USB devices, additional display ports, standardized expansion slots (e.g., ExpressCard®, FireWire®, PCI-Express, etc.), audio in and out, and/or video out, and may also be controlled by the I/O hub 320. The secondary device 300 may also include a 2D or 3D graphics controller (not shown), which may be utilized to drive basic display content when no handheld device is present. In an exemplary embodiment, the graphics controller may be system-on-a-chip-integrated with the interface controller 308. Any data or required control for these additional elements connected to the secondary device may be communicated between the handheld device 100 and secondary device 104 over the interface 102.

The secondary device 300 may further be advantageous if the secondary device 300 utilizes the computation capability of the handheld device 100, and includes a reduced number of components compared to a full computer, because the secondary device 300 may have less power consumption, be produced less expensively and in a smaller, more attractive form factor. However, in an exemplary embodiment, it may be useful for the user to access the handheld device 100 on a secondary device 300, which may also incorporate computer components to be functional as a standalone computer. In this embodiment, the secondary device 300 may allow the second user environment 117 to be displayed and controlled on the secondary device. In an exemplary embodiment, the secondary device's own computer components can be put into sleep mode or turned off to save power while the handheld device 100 is generating the second user environment 117.

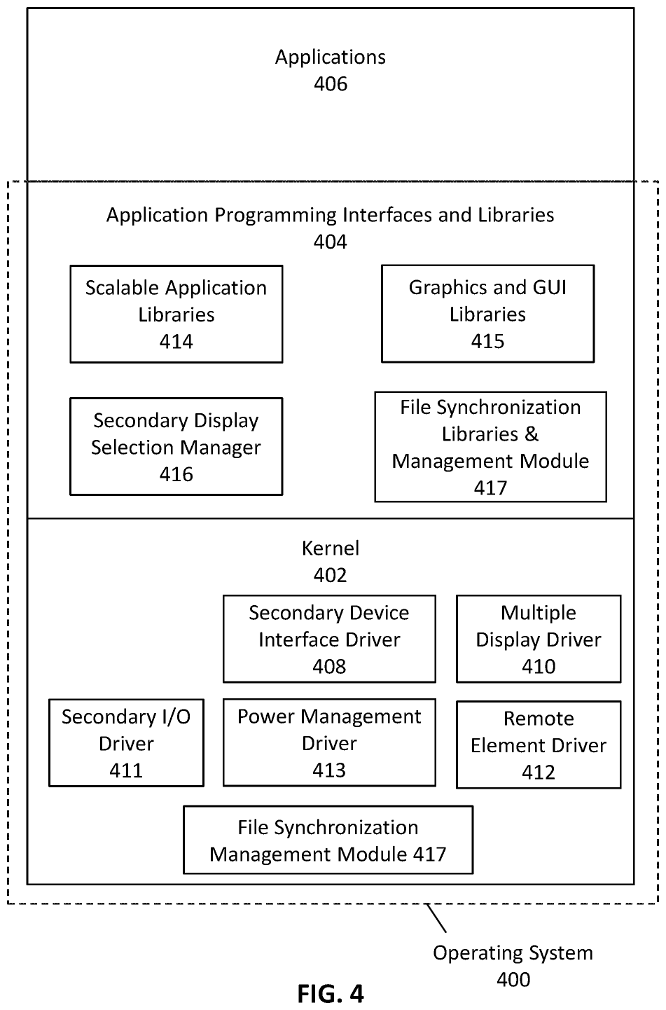

As described above, the self-configuring handheld device 100 is provided with an operating system 105, embodiments of which are described in FIG. 4. The operating system 105 once executed may, in an exemplary embodiment, provide a user environment 114 on the handheld device and may be configured to auto-detect communication with a secondary device 104a. In one embodiment, the OS 105 determines a configuration of the secondary device 104a by communicating with interface controller 308 via a handshaking procedure. The OS then itself enables a different second user environment 117 based on the configuration of the secondary device 104a, which is delivered to the secondary device and displayed on the second display 116.

FIG. 4 illustrates an exemplary embodiment of a software stack for an operating system for a handheld device that is usable with secondary devices having displays of various form factors. The operating system 400 may include a kernel 402, an application programming interface (“API”) and libraries 404, and the software stack may further include applications 406. The kernel 402 may allow applications on the handheld device to interact with hardware, both on the handheld device 100 and on the secondary device 104a. The kernel 402 may include a secondary device interface driver 408, which may enable the operating system 400 to utilize the interface 102. A multiple display driver 410, allowing use with a variety of second displays, and a remote element driver 412, for auxiliary devices utilized by the secondary device 104a (e.g., input/output devices, input/output ports, etc.) may also be included. A secondary I/O driver 411 may also be included to enable the handheld device 100 to control I/O devices of the secondary device 104a by. A power management driver 413 may also be included that extends power management to incorporate overall system power control over both the handheld device 100 and the secondary device 104a.

The API and libraries 404 may permit applications to utilize features of the operating system. In an exemplary embodiment, the secondary device interface driver 408 may perform auto-detection of secondary devices 114 through the interface 102, and a secondary display selection manager 416 that may provide a configuration library to determine which configuration for the second user environment to use with the secondary device, where the second user environment may include any combination of GUI, applications, data and file access, and I/O and display. The API and libraries 404 may also include scalable application libraries 414, which enable programmers to write applications 406 that are scalable (i.e., have a different appearance and GUI, perhaps enhanced functionality) based upon the form factor of secondary devices 104a. Graphics and GUI libraries 415 may also be included with the API and libraries 404 to support different form-factor dependent graphical user interfaces, with multi-resolution and multi-display support. Thus, the API and libraries 404 may enable applications that have different GUIs for the first user environment 114 and the second user environment 117.

Certain applications 406 may be utilized by a user both on the handheld device and on the secondary device 104a to perform tasks. Alternatively, the first and second user environments on each device may have access to different software applications, which may be advantageous when the applications are of limited utility on certain display form factors (e.g., productivity software utilizing a keyboard may be of limited utility on an automotive display). Alternatively, the first and second user environments on the handheld device and the secondary device 104a may have access to the same applications, which may be configured differently to provide different functionality on each device. For example, a slide presentation application may be only usable as a viewer on the display of the handheld device, but may have full functionality when a notebook or desktop form factor is detected. In an exemplary embodiment, the applications may be configurable by a user to provide desired functionality on each device. Since the data and files for all the applications and user environments reside on the handheld device, file and data synchronization is simplified between user environments since the files and data are unified under one device and OS. A file synchronization management module 417 in the kernel 402 tracks and coordinates file and data modifications to insure data consistency across user environments. This module can be extended to support files stored in additional peripheral mass storage devices, such as a mass storage device that might be incorporated into a secondary display device 300.

As an alternative operating system embodiment to that shown in FIG. 4, the OS 105 that runs on the handheld device 100 may support multiple virtualized OS environments, which may be different than that native OS 105. The virtualized OS environment may be assigned and automatically configured for different secondary display form factor types. For example, if the secondary device 104a has a notebook computer form factor, the handheld device may utilize a virtualized PC operating system (such as Windows or Mac OSX) that is different than the native operating system of the handheld device when the secondary device 104a is auto-detected. In other words, in the embodiment where the native OS 105 supports a virtualized OS, a second user environment is generated that runs within the virtualized OS. To manage virtualized environments, hypervisor software may be utilized by the native operating system of the handheld device 100. The virtualized OS environment, which is used to enable a second user environment 117, may run on the same processor 112 that the native OS 105 runs on or alternatively, if the processor 112 includes multiple processors, the virtualized OS may run on a different processor than the processor that runs the native OS 105. This latter option is particularly useful if the handheld OS and virtualized OS have different binary compatibility with different processor architectures. For example, a handheld OS may be compatible with the ARM processor architecture and a virtualized windows-based OS may be compatible with x86 processors. With a virtualized OS running on a secondary user environment, the file synchronization management module 417 may be extended to perform file synchronization across virtualized operating systems.

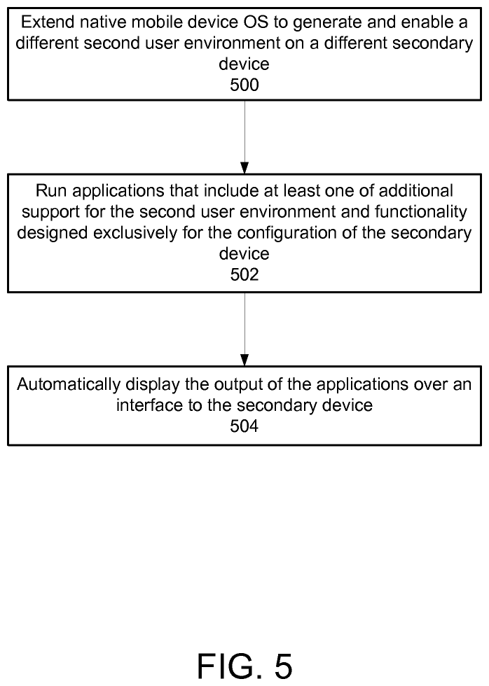

FIG. 5 illustrates a software approach to enable a handheld device to support a second user environment on a secondary device. A native handheld device OS 105 can be extended to generate and enable a different second user environment 117 on a different secondary device 104a (block 500). This may be accomplished, for example, by adding modal support for generating an alternative form-factor user environment. This can be done, for example, using various portions of the handheld device OS 105, including the API, GUI, kernel, OS drivers, and graphics library, as shown in FIG. 4. Applications may be run that include at least one of additional support for the second user environment and functionality designed exclusively for the configuration of the secondary device (block 502). In an alternative embodiment, virtualization support may be added to the handheld device OS 105, so that the second user environment is encapsulated in a virtualized environment (which may have its own OS in some embodiments) for display and user interaction on the secondary device. Alternatively, a secondary user environment may be encapsulated in a particular application, which runs on the handheld device 100 and is only displayed on the secondary device 104a.

The output of the applications may be automatically displayed over an interface to the secondary device (block 504). The native handheld device OS 105 may thereby manage the user environment delivered to the secondary device 104a and can automatically deliver and control the second user environment 117 over the interface 102 to the secondary device 104a when connected.

An expandable system architecture comprising a self-configuring handheld device that dynamically generates different user environments with secondary devices with displays of various form factors has been disclosed. The present invention is mainly described in terms of particular systems provided in particular implementations. However, this method and system may operate effectively in other implementations. For example, the systems, devices, and networks usable with the present invention can take a number of different forms. The present invention will also be described in the context of particular methods having certain steps. However, the method and system operate effectively for other methods having different and/or additional steps or steps in a different order not inconsistent with the present invention.

The present invention has been described in accordance with the embodiments shown, and there could be variations to the embodiments, and any variations would be within the scope of the present invention. For example, the present invention be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made without departing from the scope of the appended claims.

1. A non-transitory computer-readable medium containing program instructions executable by at least one processor of a handheld device including a first display with touchscreen capability and at least one frame buffer for supporting the first display and a second display, the handheld device operable with a secondary device that includes an interface controller and the second display, the program instructions including program instructions for:
generating a finger gesture control based graphical user interface (GUI) for display on the handheld device;
storing the finger gesture control based GUI in the frame buffer;
generating a different second GUI, the different second GUI being a multiple input controls GUI for an automobile display device, the multiple input controls including a microphone;
transmitting video, including the second GUI, over an interface for display on the automotive display device;
receiving input signals from the microphone for voice recognition control of the second graphical user interface; and
executing a first productivity application for display within the first graphical user interface;
executing a second application, different than the first productivity application and providing different functionality than the first productivity application, for display within the second GUI;
wherein the first GUI is part of a first user environment for the handheld device and the second GUI is part of a second user environment for the secondary device, and wherein the second user environment includes access to different data than the first user environment.

2. (canceled)

3. The non-transitory computer readable medium containing program instructions of claim 1 wherein the program instructions further include program instructions for implementing a kernel, an application programming interface (API) and libraries, and applications.

4. The non-transitory computer readable medium containing program instructions of claim 1 wherein the program instructions further include program instructions for implementing a multiple display driver that allows use of the handheld device with a variety of second displays.

5. The non-transitory computer readable medium containing program instruction of claim 1 wherein the program instructions further include program instructions for implementing a secondary I/O driver that enables the handheld device to control I/O devices of the secondary device.

6.-9. (canceled)

10. A non-transitory computer-readable medium containing program instructions for dynamically generating, by a handheld computing device having a graphics processor and at least one frame buffer, at least portions of different user environments for use one a secondary device, the program instructions including program instructions for:
generating, using the graphics processor and the at least one frame buffer, a first finger gesture control based graphical user interface for display on a touchscreen display of a computing device;
communicating over an interface with the secondary device having a second display, the second display being an automotive display;
generating, using the graphics processor and the at least one frame buffer, a different multiple inputs control graphical user interface based on a configuration indicated by the secondary device, the multiple input controls including a microphone input; the second graphical user interface being part of a second user environment which allows a user to view with the handheld computing device from the secondary device;
transmitting video, including the second graphical user interface, across an interface for display on the second display;
receiving control signals from the microphone for control of the second graphical user interface; and
executing a first application for display using the first graphical user interface and executing a second application, different than the first application and providing different functionality than the first application, for display using the second graphical user interface.

11. (canceled)

12. The non-transitory computer readable medium containing program instructions of claim 10 wherein the indication of the configuration of the secondary device is an identification code.

13.-16. (canceled)

17. The non-transitory computer readable medium containing program instructions of claim 10 wherein the program instructions further include program instructions to coordinate synchronization of file data between a first user environment of the computing device and the second user environment.

18.-20. (canceled)

21. The non-transitory computer readable medium containing program instructions of claim 10 wherein the second user environment comprises access to a plurality of applications.

22. (canceled)

23. The non-transitory computer readable medium containing program instructions of claim 10 wherein the second user environment is controlled by an operating system.

24.-29. (canceled)
